(19) United States
(12) Patent Application Publication
(10) Pub. No.: US 2005/0079829 A1
(43) Pub. Date: Apr. 14, 2005

(54) Antenna switch

(76) Inventors: Takashi Ogawa, Tokyo (JP); Hiroshi Kondoh, Fucyu (JP); Hidenori Suenaga, Komoro (JP); Akishige Nakajima, Higashiyamato (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/921,815

(22) Filed: Aug. 20, 2004

(30) Foreign Application Priority Data
Oct. 8, 2003 (JP) 2003-348990
Jun. 28, 2004 (JP) 2004-189257

(51) Int. Cl. H04B 1/44

(52) U.S. Cl. 455/83; 455/13.3

(57) ABSTRACT

An antenna switch having a simple configuration and realizing high isolation between transmitting and receiving is provided. The antenna switch has a first switch connected between a transmitting terminal 31 and an antenna terminal 4, a transmission circuit 9 whose one end is connected to the antenna terminal and which shifts a phase of a transmitting signal by 90 degrees at use frequency, a second switch 6 whose one end is connected to the other end of the transmission circuit 9 and whose other end is grounded, and a plurality of third switches 7, 8 connected between the other end of the transmission circuit 9 and the plurality of receiving terminals 32, 33.

### CLAIM OF PRIORITY

The present application claims priority from Japanese applications JP 2003-348990 filed on Oct. 8, 2003 and JP 2004-189257 filed on Jun. 28, 2004, the contents of which are hereby incorporated by reference into this application.

### FIELD OF THE INVENTION

The present invention relates to an antenna switch for switching connection between a plurality of transmitting and receiving circuits and an antenna commonly used by the transmitting and receiving circuits.

### BACKGROUND OF THE INVENTION

An antenna switch for switching connection between transmitting and receiving circuits handling a transmitted signal of a high output exceeding one watt and an antenna is strongly demanded to handle a high handling voltage and to have isolation between transmitting and receiving so that a transmitted signal is not leaked to a receiving circuit at the time of transmitting.

An antenna switch addressing such requests is disclosed in Japanese Patent Laid-open No. 2002-111301. A circuit disclosed in the document will be described with reference to FIG. 10. A power amplifier 102 having an input terminal 101 is connected to a transmitting terminal 112 for receiving an output signal of the power amplifier 102 and an antenna terminal 104 via a switching element 103 having one input and one output using a field effect transistor. One end of a transmission circuit 105 is connected to the antenna terminal 104 and the other end is connected to a switching element 107 having one input and one output using a field effect transistor and a receiving terminal 106. One end of the switching element 107 is grounded and the length of the transmission circuit 105 is ¼ of an effective wavelength.

The conductive state of the switching element using a field effect transistor is expressed by a low impedance component mainly using on-state resistance between the drain (D) and the source (S) of the transistor. On the other hand, the nonconductive state is expressed by a high impedance component by a depletion layer between the drain and source of the transistor. The states are controlled by a voltage applied from a gate terminal Tg to which the gate (G) is connected.

In the case of outputting a high-power signal from the power amplifier 102 to the antenna terminal 104, the switching elements 103 and 107 become conductive, and the receiving terminal 106 is grounded. Since the length of the transmission circuit 105 is ¼ of the effective wavelength, impedance conversion is made, so that the impedance of the receiving terminal 106 seen from the antenna terminal 104 is high. Consequently, a transmitted signal is not transmitted to the receiving terminal 106. A voltage applied across the switching elements 103 and 107 is low since they are in the conductive state.

Since the switching elements 103 and 107 become nonconductive at the time of receiving, a signal received from the antenna is not transmitted to the transmitting terminal 112 but is transmitted to the receiving terminal 106.

FIG. 11 shows dependency on frequency of isolation between transmitting and receiving at the time of transmitting in the configuration. For example, the frequency range in which isolation of 20 dB is obtained is 2.0±0.2 GHz. The band is narrow, and the maximum value of isolation is about 23 dB and is low.

FIG. 12 shows a part of a circuit disclosed by H. Tosaka et al., “An Antenna Switch MMIC Using E/D Mode p-HEMT for GSM/DCS/PCS/WCDMA Bands Application”, 2003 IEEE MTT-S International Microwave Symposium Digest, Vol. 1, No. IFTU-50, pp. A5 to A8. The circuit in the diagram is an antenna switch for switching connection between an antenna terminal 111 and the transmitting terminal 112 and receiving terminals 113, 114, and 115 by high handling voltage switches 116. At the time of transmitting a high output signal, the switch connected to the transmitting terminal 112 is made conductive. The switches connected to the receiving terminals 113 to 115 are made nonconductive and a high voltage is applied.

Since the handling voltage of the switch is determined by the handling voltage of a depletion layer capacity of a transistor used as the switch, multistage connection of transistors is necessary for assuring a handling voltage. In the case of the paper of H. Tosaka et al, the high handling voltage switch 116 needs connection of four stages between i and j by a single gate configuration as shown in FIG. 13.

### SUMMARY OF THE INVENTION

FIG. 14 shows that the antenna switch illustrated in FIG. 10 is extended to an antenna switch for switching connection among one transmitting circuit, two receiving circuits, and one antenna. Since the isolation characteristic is a narrow band, a transmission circuit 108 having a length corresponding to ¼ of the effective wavelength and a switch 110 are necessary for each kind of operating frequencies of the circuit between a receiving terminal 109 and the antenna terminal 104. As the number of kinds of operating frequencies increases, the number of transmission circuits to be added increases, and the configuration of the antenna switch becomes complicated.

Also in the circuit shown in FIG. 12, a switch is necessary for each receiving circuit. As the number of receiving circuits increases, the number of high handling voltage switches increases, and the configuration of the antenna switch becomes complicated. Further, to prevent increase in an insertion loss in multistage connection, a transistor having a large gate width is necessary as the high handling voltage switch. Consequently, the device area is enlarged and the chip area is enlarged.

A main object of the invention is to provide an antenna switch having a simple configuration and capable of obtaining high isolation between transmitting and receiving.

An additional object of the invention is to provide an antenna switch in which a switch element area can be prevented from being enlarged.

An antenna switch of the invention for achieving the main object is an antenna switch for connecting an antenna terminal selectively to any of a transmitting terminal to which a transmitted signal is inputted and a plurality of receiving terminals for outputting received signals, and includes: a first switch connected between the transmitting terminal and the antenna terminal; a transmission circuit whose one end is connected to the antenna terminal, for shifting the phase of a transmitted signal by 90 degrees at used frequency; a second switch whose one end is connected to the other end of the transmission circuit and whose other end is grounded; and a plurality of third switches connected between the other end of the transmission circuit and the plurality of receiving terminals.

Since the transmission circuit is commonly used by the plurality of receiving terminals, the configuration is simple. Further, isolation between transmitting and receiving is obtained by two stages of a combination of the transmission circuit and the second switch and the third switch, so that high isolation can be obtained.

An antenna switch of the invention for achieving the additional object is an antenna switch for connecting an antenna terminal selectively to any of a transmitting terminal to which a transmitted signal is inputted and a plurality of receiving terminals from which received signals are output, and includes: a first switch connected between the transmitting terminal and the antenna terminal; a second switch whose one end is connected to the antenna terminal; and a plurality of third switches each connected between the other end of the second switch and each of the plurality of receiving terminals.

Since the second switch is commonly used by the plurality of receiving terminals, the configuration is simple. Further, isolation between transmitting and receiving is obtained by two stages of the second switch and the third switch, so that high isolation can be obtained. Since the handling voltage of the third switch can be lower than that of the second switch, the device area of the switches can be prevented from being enlarged as the number of receiving terminals increases.

These and other objects and many of the attendant advantages of the invention will be readily appreciated, as the same becomes better understood by reference to the following detailed description when considered in connection with the accompanying drawings.

### BRIEF DESCRIPTION OF THE DRAWINGS

FIG. 1 is a circuit diagram for illustrating a first embodiment of an antenna switch according to the invention.

FIG. 2 is a graph showing an isolation characteristic between transmitting and receiving of the first embodiment.

FIG. 3 is a circuit diagram for illustrating a second embodiment of the invention.

FIG. 4 is a circuit diagram for illustrating a third embodiment of the invention.

FIG. 5 is a circuit diagram for illustrating a fourth embodiment of the invention.

FIG. 6 is a circuit diagram showing an example of a switch used in the fourth embodiment.

FIG. 7 is a circuit diagram showing another example of the switch used in the fourth embodiment.

FIG. 8 is a circuit diagram showing further another example of the switch used in the fourth embodiment.

FIG. 9 is a circuit diagram for illustrating a fifth embodiment of the invention.

FIG. 10 is a circuit diagram for illustrating an example of a conventional antenna switch.

FIG. 11 is a graph showing an isolation characteristic between transmitting and receiving of the antenna switch of FIG. 10.

FIG. 12 is a circuit diagram showing another example of the conventional antenna switch.

FIG. 13 is a circuit diagram showing a switch used in the antenna switch of FIG. 12.

FIG. 14 is a circuit diagram for illustrating an example of an antenna switch constructed based on the conventional technique.

FIG. 15 is a circuit diagram illustrating a sixth embodiment of the invention.

### DETAILED DESCRIPTION OF THE PREFERRED EMBODIMENTS

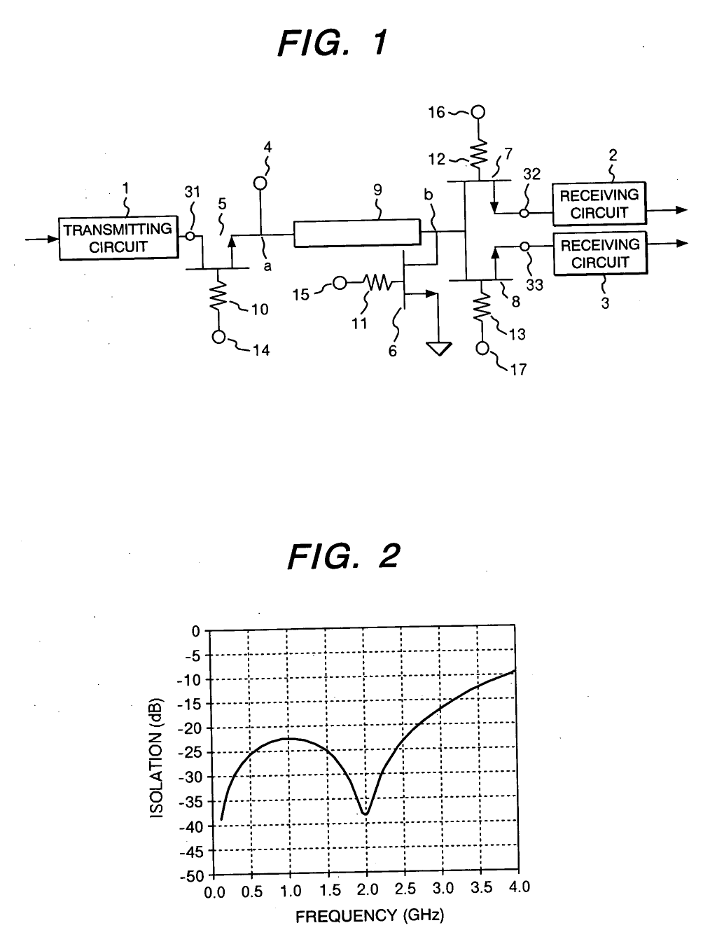

An antenna switch according to the invention will be described in detail hereinbelow by referring to embodiments shown in the drawings. The same reference numeral in FIGS. 1, 3, 4, 5, and 9 denotes the same or similar component and repetitive description will not be given.

A first embodiment of the invention will be described with reference to FIG. 1. FIG. 1 shows an antenna switch for switching connection among a transmitting circuit 1 handling a transmitted signal of a high output, two receiving circuits 2 and 3, and one antenna terminal 4.

A switching element 5 having one input and one output is connected between a transmitting terminal 31 for receiving an output signal of the transmitting circuit 1 and the antenna terminal 4. One end of a transmission circuit 9 is connected to the antenna terminal 4, and one end of a switch 6 having one input and one output is connected to the other end of the transmission circuit 9. The other end of the switch 6 is grounded. The length of the transmission circuit 9 is ¼ of the effective wavelength. The transmission circuit 9 turns the phase of a transmitted signal by 90 degrees at a frequency used. A switch 7 having one input and one output is connected between a receiving terminal 32 for supplying a received signal to the receiving circuit 2 and one end of the switch 6. A switch 8 having one input and one output is connected between a receiving terminal 33 for supplying a received signal to the receiving circuit 3 and one end of the switch 6.

The switches 5 to 8 are constructed by HEMT (High Electron Mobility Transistor) devices. Terminals 14 to 17 are control terminals for controlling a conductive/nonconductive state of the switches 5 to 8, respectively. Resistive elements 10 to 13 are used for isolating the terminals 14 to 17 from the switches 5 to 8 in high frequency.

At the time of transmitting, the switches 5 and 6 are made conductive and the switches 7 and 8 are made nonconductive. At this time, the impedance seen from the connection point “a” of the antenna terminal 4, switch 5, and transmission circuit 9 to the connection point “b” of the switch 6 and the transmission circuit 9 is high since the connection point “b” is grounded with low impedance via the switch 6 and the phase in the transmission circuit is shifted by 90 degrees.

The amount of isolation between the connection points “a” and “b” is determined by the impedance indicating the conductive state of the switch 6. Since the HEMT devices are used in the embodiment, higher isolation can be realized as compared with other field effect transistors such as a JFET (Junction Field Effect Transistor) device and an MESFET (Metal Semiconductor Field Effect Transistor) device.

Between the connection point “a” and the receiving circuits 2 and 3, isolation by the nonconductive switches 7 and 8 is added to the above-described isolation between the connection points“a” and “b”. Since the nonconductive switches 7 and 8 are capacitive, the lower the frequency is, the higher the isolation is.

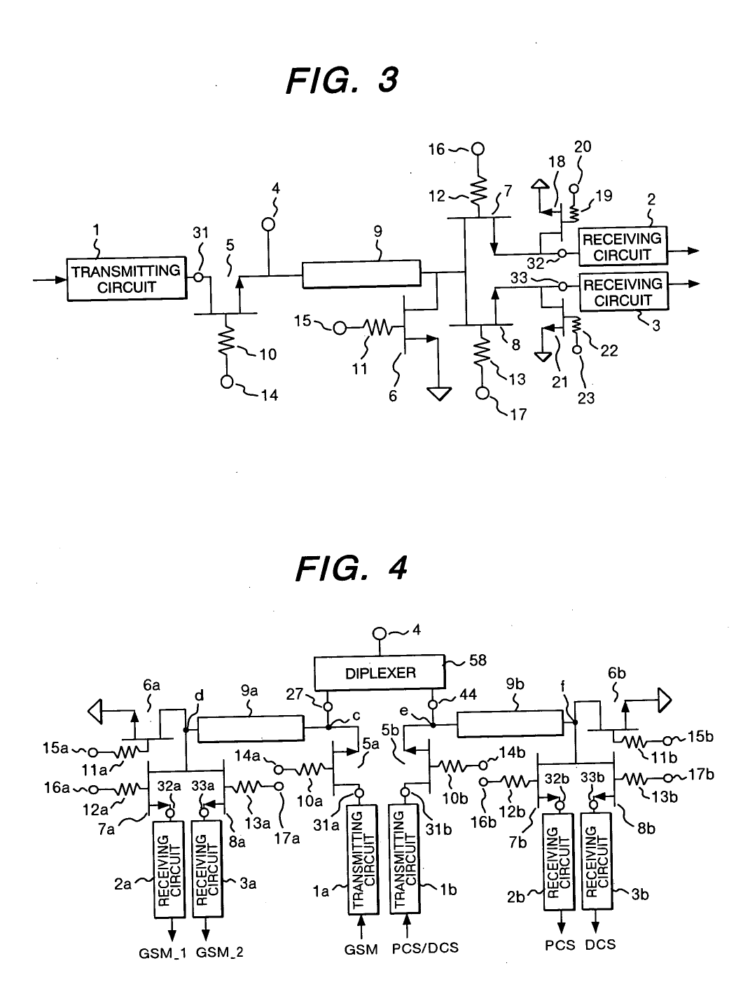

FIG. 2 shows the isolation characteristic of the embodiment obtained as described above. Isolation of 20 dB is obtained in a wide band of 2.7 GHz or less. In the embodiment, high isolation between the connection point “a” and the receiving circuits 2 and 3 can be realized in a wide frequency range by both of isolation between the transmission circuit 9 and the switch 6 and isolation between the switches 7 and 8. Therefore, a signal leakage from the connection point “a” to the receiving circuits 2 and 3 decreases and a transmitted signal of high output from the transmitting circuit 1 is transmitted with low loss to the antenna terminal 4.

The switches 5 and 6 are not requested to handle a high voltage since they become conductive at the time of transmitting. The switches 7 and 8 are also not requested to handle a high voltage since the transmitted signal sufficiently attenuates due to isolation between the transmission circuit 9 and the switch 6. Since the transmitted signal attenuates sufficiently, the switches 7 and 8 do not exert an influence of loss and distortion on the transmitted signal. That is, the switch hardly exerting loss and distortion to a transmitted signal is provided.

Subsequently, an operation at the time of receiving will be described by using the case of receiving a signal by the receiving circuit 2 will be described. The switches 5 and 6 become nonconductive, the switch 7 becomes conductive, and the switch 8 becomes nonconductive. A signal received from the antennal terminal 4 is transmitted to the receiving circuit 2 via the transmission circuit 9 and the switch 7. Since the switches 5 and 8 are in a nonconductive state, the signal is not transmitted to the transmitting circuit 1 and the receiving circuit 3. Since the received signal is of low power, there is no problem of distortion.

In the case where the transmitting frequency is the same, the transmission circuit can be commonly used. Consequently, the number of receiving circuits is not limited to two as in the embodiment but may be three or more.

FIG. 3 shows a second embodiment of the invention. In the second embodiment, to further improve isolation between transmitting and receiving at the time of transmitting and isolation between receivings, a switch 18 whose one end is grounded is connected between the switch 7 and the receiving circuit 2 and, moreover, a switch 21 whose one end is grounded is connected between the switch 8 and the receiving circuit 3. The switches 18 and 21 are constructed by HEMT devices.

Terminals 20 and 23 are control terminals for controlling the conductive state and the nonconductive state of the switches 18 and 21, respectively. Resistive elements 19 and 22 are used for isolation between the terminals 20 and 23 and the HEMT switches 18 and 21 in high frequency.

By making the switches 18 and 21 conductive at the time of transmitting, isolation at the time of transmitting is improved. At the time of receiving, by making the switch connected to a receiving circuit which receives a signal nonconductive and making the switch connected to a circuit which does not receive a signal conductive, the non-receiving circuit is grounded. In such a manner, isolation between the receiving circuits is improved.

FIG. 4 shows a third embodiment of the invention. The third embodiment relates to an antenna switch constructed to support a plurality of communication standards of cellular phone and can switch connected among GSM (Global System for Mobile communications), PCS (Personal Communication Services), and DCS (Digital Communication System) as existing communication standards. In the GSM, one system is used for transmitting whereas two systems are used for receiving. In the PCS and DCS, by commonly using a transmitting circuit, one system is used for transmitting in both of the PCS and DCS, one system is used for receiving in the PCS, and one system is used for receiving in the DCS.

Since the 900 MHz band is used for the GSM and the 1800 MHz band is used for the PCS and DCS, the length of the transmission circuit in which the phase is shifted by 90 degrees varies largely between the GSM and the PCS and DCS. Consequently, the GSM and the PCS and DCS are isolated from each other by using a diplexer 58 having the antenna terminal 4, a GSM terminal 27, and a PCS/DCS terminal 44. The switch of FIG. 1 is connected to each of the GSM terminal 27 and the PCS/DCS terminal 44.

Specifically, the third embodiment relates to an antenna switch constructed between the antenna terminal 4 and a transmitting terminal 31a and receiving terminals 32a and 33a and between the antenna terminal 4 and a transmitting terminal 31b and receiving terminals 32b and 33b. The GSM terminal 27 and the PCS/DCS terminal 44 will be called sub antenna terminals and the antenna switch in FIG. 1 on the GSM side and the antenna switch in FIG. 1 on the PCS/DCS side will be called sub antenna switches. As reference numerals in for the sub antenna switch, reference numerals obtained by adding subscripts “a” and “b” to the reference numerals of FIG. 1 are used.

The length of a transmission circuit 9a is set to a length in which the phase of a transmitted signal is shifted by 90 degrees at the transmitting frequency of the GSM, and the length of a transmission circuit 9b is set to a length in which the phase of a transmitted signal is shifted by 90 degrees at the transmitting frequency of the PCS/DCS.

At the time of transmitting of the GSM, switches 5a and 6a become conductive and switches 7a and 8a become nonconductive. At this time, the impedance of a connection point “d” seen from a connection point “c” becomes high by the transmission circuit 9a and the switch 6a. Further, the impedance of the receiving circuits 2a and 3a seen from the connection point “d” becomes also high. Thus, high isolation between transmitting and receiving is realized over a wide frequency band. Consequently, a transmitted signal of high output sent from the transmitting circuit la is transmitted to the antenna terminal 4 via the switch 5a, terminal 27, and diplexer 58 without being leaked to the receiving circuit.

Although the transmitted signal of high output reaches 4 W at the maximum, due to the conductive state of the switches 5a and 6a, a voltage applied to the switches 5a and 6a is less than 1V. Since only a voltage of the same level is also applied to the switches 7a and 8a in the nonconductive state, the influence of distortion is hardly exerted on the transmitted signal.

The operation at the time of GSM receiving will now be described by using the case where the receiving circuit 2a performs receiving operation. Since the switches 5a, 6a, and 8a become nonconductive and the switch 7a becomes conductive, a GSM received signal supplied from the antenna terminal 4 is output to the terminal 27 via the diplexer 58 and is transmitted to the receiving circuit 2a via the switch 7a. Since the intensity of the received signal is weak, there is no problem of distortion given to the received signal. In the case where the receiving circuit 3a performs receiving operation, the switches 5a, 6a, and 7a become nonconductive and the switch 8a becomes conductive.

At the time of PCS/DCS transmitting, the switches 5b and 6b become conductive and the switches 7b and 8b become nonconductive. At this time, the impedance of a connection point “f” seen from a connection point “e” becomes high by the transmission circuit 9b and the switch 6b. Further, the impedance of the receiving circuits 2b and 3b seen from the connection point “f” becomes also high. Thus, high isolation between transmitting and receiving is realized over a wide frequency band. Consequently, a transmitted signal of high output sent from the transmitting circuit 1b is transmitted to the antenna terminal 4 via the switch 5b, terminal 44, and diplexer 58 without being leaked to the receiving circuit. The transmitted signal of high output reaches to 2 to 3 W at the maximum. However, as the switches 5b and 6b are conductive, the voltage applied to the switches 5b and 6b is less than 1V. Since only the same level of voltage is applied to the switches 7b and 8b in the nonconductive state, the influence of distortion exerted on the transmitted signal is small.

At the time of PCS receiving, the switches 5b, 6b, and 8b are in the nonconductive state and the switch 7b is in the conductive state, so that a PCS received signal supplied from the antenna terminal 4 is output to the terminal 44 via the diplexer 58 and is transferred to the receiving circuit 2b via the switch 7b. Since the intensity of the received signal is low, there is no problem of distortion given to the received signal.

At the time of DCS receiving, the switches 5b, 6b, and 7b are in the nonconductive state, the switch 8b is in the conductive state, and the received signal is transmitted to the receiving circuit 3b.

The terminals 14a to 17a and 14b to 17b are control terminals for controlling the conductive/nonconductive state of the switches. The resistive elements 10a to 13a and 10b to 13b are used for isolating the control terminals from the corresponding switches in high frequency.

By the embodiment, the antenna switch in which high isolation is maintained between transmitting and receiving and between receivings over a wide frequency range while supporting a plurality of communication standards and a low loss is achieved between the antenna and the circuits can be realized.

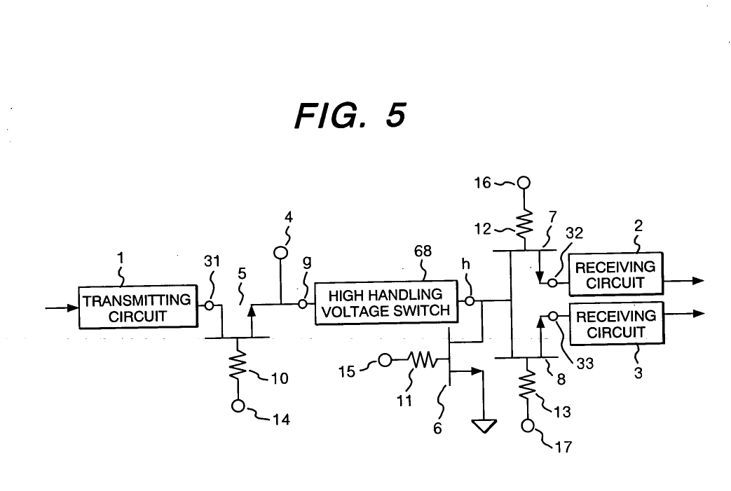

FIG. 5 shows a fourth embodiment of the invention. In the fourth embodiment, a switch 68 is used in place of a transmission circuit. The fourth embodiment relates to an antenna switch for switching connection among one transmitting circuit 1 for handling a high-output transmitted signal, two receiving circuits 2 and 3, and one antenna terminal 4 without using a transmission circuit. The switches 5, 7, and 8 are constructed by HEMT devices.

At the time of transmitting, the switch 5 is made conductive and the switches 7, 8, and 68 are made nonconductive. The switch 68 is requested to sufficiently handle a high voltage in a nonconductive state so that a high-output transmitted signal output from the transmitting circuit 1 is transmitted to the antenna terminal 4 with a low loss and a little distortion. The transmitted output signal in the antenna terminal 4 reaches 4 W at the maximum and a voltage of about 27V is applied to the high handling voltage switch 68.

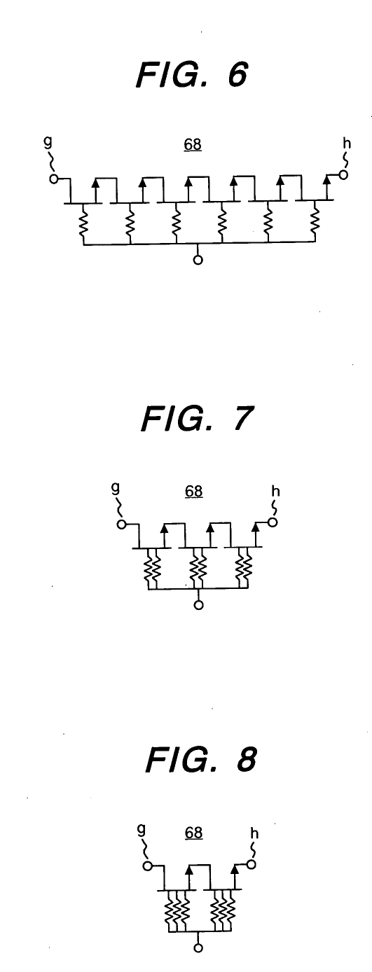

As switch elements for assuring handling of the high voltage, multi-stage connection of HEMTs is used as the high handling voltage switch 68. The high handling voltage switch 68 in the case where the pinch-off voltage is set to −0.5 to −1.0V and the control voltage is set to −2.8V has to have connection of four to six stages in a single gate configuration as shown in FIG. 6, connection of two to three stages in a dual gate configuration as shown in FIG. 7, and connection of two stages in a triple gate configuration as shown in FIG. 8.

By isolation of the switch 68, the power of the transmitted signal is sufficiently attenuated, so that each of the switches 7 and 8 can be constructed by a single gate. When the isolation of the switch 68 has to be compensated, the switch 6 whose one end is grounded is connected between the high handling voltage switch 68 and the switches 7 and 8. By setting the switch 6 in the same operating conditions as those of the switch 5, the isolation is improved and distortion of the switches 7 and 8 can be further reduced. The switch 6 is also constructed by an HEMT.

In the embodiment, although a high handling voltage switch is conventionally necessary for each receiving circuit, only the common high handling voltage switch 68 is sufficient. Thus, the device area of the switch can be prevented from being enlarged.

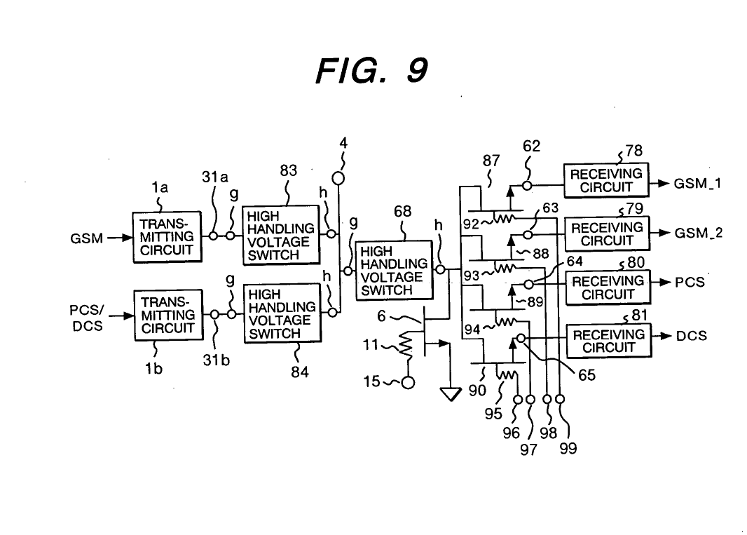

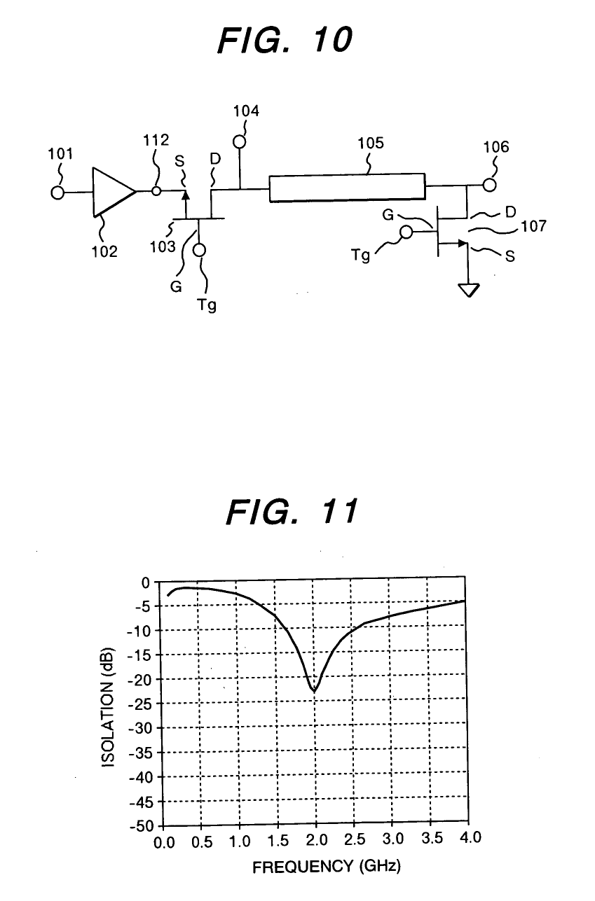

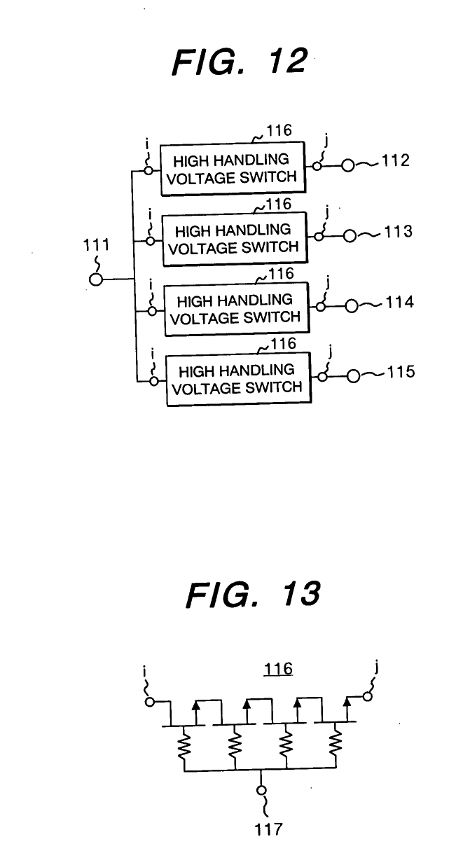

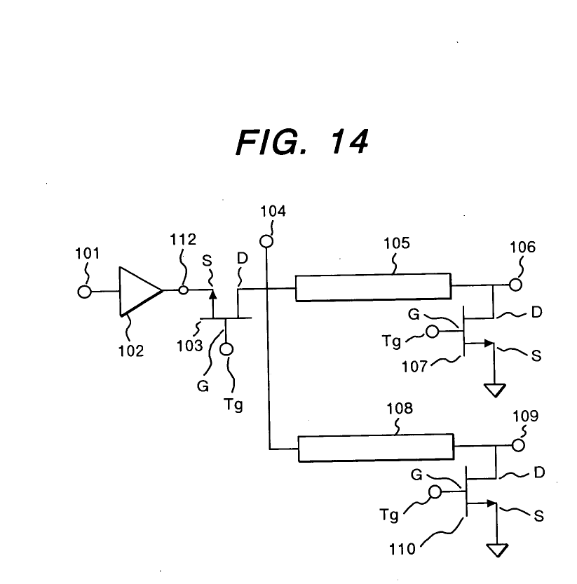

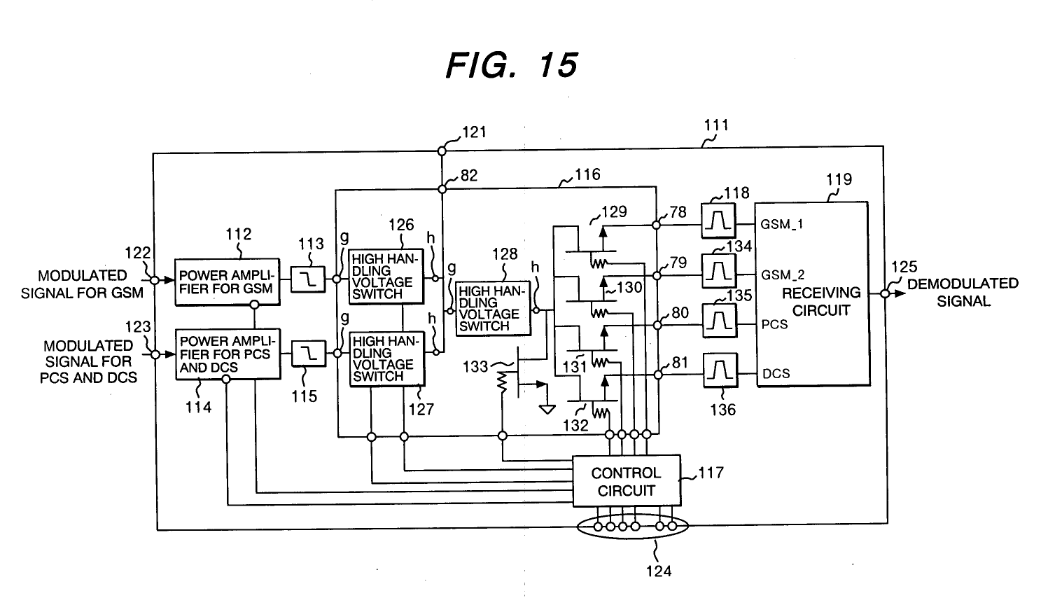

FIG. 9 shows a fifth embodiment of the invention. The fifth embodiment relates to an antenna switch capable of switching connection among the GSM, PCS, and DCS of cellular phone. In the GSM, one system is used for transmission and two systems are used for reception. In the PCS and DCS, by commonly using a transmitting circuit, one system is used for transmission in both of the PCS and DCS, one system is used for receiving in the PCS, and one system is used for receiving in the DCS.

A high handling voltage switch 83 is connected between the antenna 4 and the transmitting terminal 31a connected to the transmitting circuit 1a, a high handling voltage switch 84 is connected between the antenna terminal 4 and the transmitting terminal 31b connected to the transmitting circuit 1b, and the high handling voltage switch 68 is connected to the antenna terminal 4. Further, switches 87 to 90 are connected between the high handling voltage switch 68 and receiving circuits 78 to 81, respectively. Terminals 96 to 99 are control terminals for controlling the conductive/nonconductive state of the switches 87 to 90, respectively. Resistive elements 92 to 95 are used to isolate the control terminals from the corresponding switches in high frequency.

As the switches 83, 84, and 68, the high handling voltage switches shown in FIGS. 6, 7, and 8 are used so that distortion does not occur even when the maximum output power reaches 4 W in the GSM mode. When the isolation of the high handling voltage switch 68 has to be compensated, the switch 6 is provided.

At the time of GSM transmitting, the switches 83 and 6 are in the conductive state and the switches 84, 68, 87, 88, 89, and 90 are in the nonconductive state. A high output transmitted signal which is output from the transmitting circuit 1a is transmitted to the antenna terminal 4.

At the time of PCS/DCS transmitting, the switches 84 and 6 are in the conductive state and the switches 83, 68, 87, 88, 89, and 90 are in the nonconductive state. A high output transmitted signal which is output from the transmitting circuit 1b is transmitted to the antenna terminal 4.

At the time of receiving, the switches 83, 84, and 6 are in the nonconductive state and the switch 68 is in the conductive state. Among the switches 87 to 90, only a switch connected to a receiving circuit for receiving a signal is made conductive, and the other switches are made nonconductive. Therefore, a received signal input from the antenna terminal 4 is transmitted to the receiving circuit via the switch which is made conductive. The terminals 96 to 99a recontrol terminals for controlling the conductive/nonconductive state of the switches 87 to 90, and the resistive elements 92 to 95 are used for isolating the control terminals from the corresponding switches in high frequency.

In the embodiment, while supporting the plural communication standards, the device area of the switches can be prevented from being enlarged.

FIG. 15 shows a sixth embodiment of the invention. The sixth embodiment relates to a RF (Radio Frequency) module constructed by using the antenna switch of the fifth embodiment and supports the GSM, PCS, and DCS of cellular phone. In the GSM, one system is used for transmitting and two systems (GSM_{—}1 and GSM_{—}2) are used for receiving. In the PCS and DCS, by commonly using a transmitting circuit, one system is used for transmitting in both of the PCS and DCS, one system is used for receiving in the PCS, and one system is used for receiving in the DCS.

In an RF module 111 of the sixth embodiment, the following components are mounted; a power amplifier 112 for GSM, a low pass filter 113 for removing harmonics of the power amplifier 112 for GSM, a power amplifier 114 for PCS/DCS, a low pass filter 115 for removing harmonics of the power amplifier 114 for PCS/DCS, an antenna switch 116 shown in the fifth embodiment of the invention, a control circuit 117 for controlling output powers of the power amplifiers 112 and 114 and controlling switch of connection of the switch 116, SAW filters 118, 134, 135, and 136 for removing noise which disturbs received signals connected to the receiving terminals of the switches, and a receiving circuit 119. The RF module 111 has an antenna terminal 121, a modulated signal terminal 122 for GSM, a modulated signal terminal 123 for PCS/DCS, a terminal 124 for supplying a bias and a control signal to the control circuit, and a demodulated signal terminal 125.

The antenna switch 116 is similar to that of FIG. 9. Each of switches 126, 127, and 128 of the high handling voltage switch in the antenna switch 116 is constructed by three stages of dual gates. Alternately, it can be constructed by six stages of single gates shown in FIG. 6 or two stages of triple gates as shown in FIG. 8. The chip size of the integrated circuit is about 1 mm².

The operation of the sixth embodiment performed at the time of transmitting/receiving in the PCS will be described as an example. At the time of receiving of PCS, the power amplifiers 112 and 114 are in the nonconductive state, the switches 126, 127, 129, 130, 132, and 133 are in the nonconductive state, and the switches 128 and 131 are in the conductive state. Consequently, a received signal which is input from the terminal 121 is supplied to the receiving circuit 119 via the switches 128 and 131 and the SAW filter 135 and demodulated, and the demodulated signal is output to the terminal 125.

At the time of transmitting in the PCS, since the operation frequencies overlap in a band from 1,850 MHz to 1875 MHz in PCS transmitting frequencies and DCS receiving frequencies, when a PCS transmitted signal in the band is output, the power supplied to an SAW filter 136 is determined by the isolation between the PCS transmitting and the DCS receiving. When isolation is insufficient, the power of the PCS transmitted signal supplied to the SAW filter 136 becomes excessive, so that the SAW filter 136 may be destroyed and, further, the receiving circuit 119 may be destroyed. In the sixth embodiment, high isolation is obtained by the switches 128, 132, and 133, so that such destruction is avoided.

At the time of PCS transmitting, by the control circuit 117, the power amplifier 112 for GSM is made nonconductive, the switches 126, 128, 129, 130, 131, and 132 are made nonconductive, the power amplifier 114 for PCS/DCS is made operative, and the switches 127 and 133 are made conductive. A signal input to the terminal 123 is amplified by the power amplifier 114 for PCS/DCS, and the amplified signal is output to the terminal 121 via the switch 127. Since the switches 128, 129, 130, 131, and 132 are in the nonconductive state and the switch 133 is in the conductive state, high isolation can be obtained over a wide frequency band. Therefore, the SAW filter 136 on the reception side and the receiving circuit 119 can be prevented from being destroyed.

In the case where the length of an RF transmission path connected to the high handling voltage switch is equal to or less than 1/10 of the wavelength in the transmission path of the operation frequency of the switch, when a high frequency power exceeding 1 W is supplied to the switch, even when the length of the RF transmission path changes, the high handling voltage switch has to maintain the of f state. Consequently, in the embodiment, as the switches 126, 127, and 128, multistage connection of single gates, a multi-gate single body such as a dual gate or triple gate body, or multistage connection of the multi-gates is used. A switch of one stage of a single gate can maintain the off state only when the power supplied is less than 1 W, so that it cannot be used as a high handling voltage switch.

By using the antenna switch of the invention for an RF module for performing transmitting and receiving, a higher transmission power can be handled because of the high handling voltage characteristic of the switch. Moreover, by series connection of the high handling voltage switch and the mode changeover switch, high isolation can be realized between transmitting and receiving. Thus, large passive parts such as duplexer become unnecessary and a thinner and smaller RF module can be realized.

According to the invention, in an antenna switch for switching connection between a plurality of transmitting/receiving terminals and an antenna terminal, high isolation and low loss can be realized over a wide frequency band.

It is further understood by those skilled in the art that the foregoing description is a preferred embodiment of the disclosed device and that various changes and modifications may be made in the invention without departing from the spirit and scope thereof.

1. An antenna switch for selectively connecting any of a transmitting terminal to which a transmitted signal is inputted and a plurality of receiving terminals from which received signals are outputted to an antenna terminal, comprising:
a first switch connected between said transmitting terminal and said antenna terminal;
a transmission circuit whose one end is connected to said antenna terminal and from whose other end a transmitted signal whose phase is shifted by desired degrees is obtained at use frequency;
a second switch whose one end is connected to said other end of said transmission circuit and whose other end is grounded in alternate current; and
a plurality of third switches connected between said other end of said transmission circuit and said plurality of receiving terminals.

2. The antenna switch according to claim 1, wherein said first to third switches are constructed by HEMT devices.

3. The antenna switch according to claim 1, further comprising a fourth switch whose one end is connected to each of said plurality of receiving terminals and whose other end is grounded.

4. An antenna switch comprising:
two sub antenna switches for selecting connecting any of a transmitting terminal to which a transmitted signal is inputted and a plurality of receiving terminals from which received signals are outputted to a sub antenna terminal; and
a diplexer connected between an antenna terminal and said two sub antenna terminals,
each of said sub antenna switches comprising:
a first switch connected between said transmitting terminal and said sub antenna terminal;
a transmission circuit whose one end is connected to said sub antenna terminal and from whose other end a transmitted signal whose phase is shifted by desired degrees is obtained at use frequency;
a second switch whose one end is connected to said other terminal of said transmission circuit and whose other end is grounded in alternate current; and
a plurality of third switches connected between said other end of said transmission circuit and said plurality of receiving terminals.

5. An antenna switch for selectively connecting any of a transmitting terminal to which a transmitted signal is inputted and a plurality of receiving terminals from which received signals are outputted to an antenna terminal, comprising,:
a first switch connected between said transmitting terminal and said antenna terminal;
a seconds witch whose one end is connected to said antenna terminal and whose other end is coupled to selected one of said plurality of receiving terminals; and
a plurality of third switches each inserted in a coupling path between said other end of said second switch and each of said plurality of receiving terminals.

6. The antenna switch according to claim 5, wherein said first to third switches are constructed by HEMT devices.

7. The antenna switch according to claim 6, wherein a handling voltage of said second switch is higher than that of said third switch.

8. The antenna switch according to claim 5, further comprising a fourth switch whose one end is connected to said other end of said second switch and whose other end is grounded in alternate current.

9. The antenna switch according to claim 5, further comprising a fifth switch connected between another transmitting terminal and said antenna terminal.

10. The antenna switch according to claim 9, wherein said first to third switches and said fifth switch are constructed by HEMT devices, and a handling voltage of said first, second and fifth switches is higher than that of said third switch.

11. The antenna switch according to claim 5, wherein said second switch is a high handling voltage switch constructed by a plurality of transistors in which switch current paths are connected in series.

12. An RF module comprising:
an antenna switch; and
at least one of a transmitting circuit and a receiving circuit,
wherein said antenna switch selectively connects any of a transmitting terminal to which a transmitted signal is inputted and a plurality of receiving terminals from which received signals are outputted to an antenna terminal, and comprises:
a first switch connected between said transmitting terminal and said antenna terminal;
a second switch whose one end is connected to said antenna terminal and whose other end is coupled to selected one of said plurality of receiving terminals; and
a plurality of third switches each inserted in a coupling path between said other end of said second switch and each of said plurality of receiving terminals.

13. The RF module according to claim 12, wherein said first to third switches are constructed by HEMT devices.

14. The RF module according to claim 13, wherein a handling voltage of said second switch is higher than that of said third switch.

15. The RF module according to claim 12, further comprising a fourth switch whose one end is connected to said other end of said second switch and whose other end is grounded in alternate current.

16. The RF module according to claim 12, further comprising a fifth switch connected between another transmitting terminal and said antenna terminal.

17. The RF module according to claim 16, wherein said first to third switches and said fifth switch are constructed by HEMT devices, and a handling voltage of said first, second, and fifth switches is higher than that of said third switch.

18. The RF module according to claim 12, wherein said second switch is a high handling voltage switch constructed by a plurality of transistors in which switch current paths are connected in series.
